(19) United States
(12) Patent Application Publication
(10) Pub. No.: US 2007/0127045 A1
(43) Pub. Date: Jun. 7, 2007

(54) Arrangement for data transmission between an image source and an image reproducing system

(75) Inventors: Klaus Burkhardt, Kraichtal (DE); Gunter Gerner, Stutensee (DE); Andreas Karcher, Weingarten (DE); Uwe Nagel, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/607,350

(22) Filed: Dec. 1, 2006

(30) Foreign Application Priority Data
Dec. 2, 2005 (DE) 10 2005 057 779.2

(51) Int. Cl. G06F 15/00

(52) U.S. Cl. 358/1.9

(57) ABSTRACT

In one aspect an arrangement for data transmission between an image source and an image reproducing system is build, with digital R/G/B video signals being able to be fed to the image reproducing system via an R/G/B path pair in each instance and a communication signal. Measures are proposed which reduce the transmission time required to transmit large data volumes in a communication operating mode.

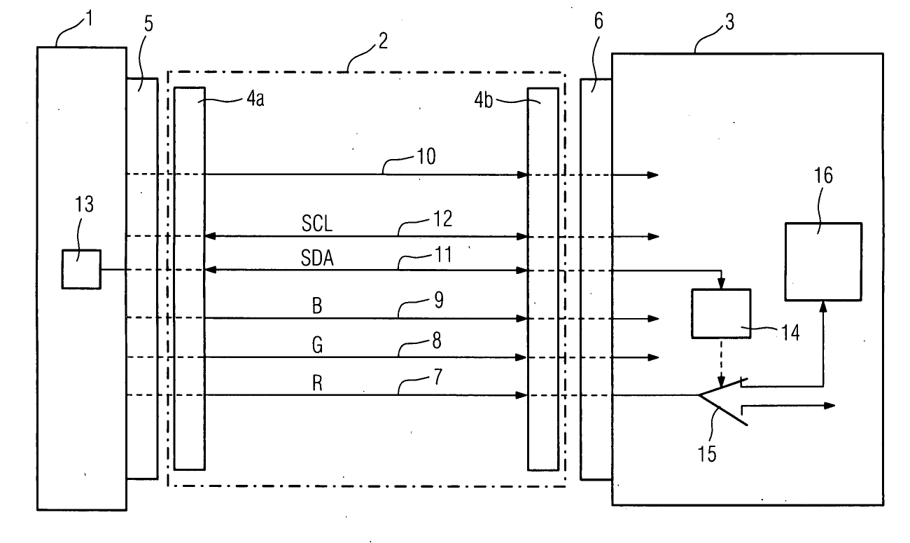

### CROSS REFERENCE TO RELATED APPLICATIONS

This application claims priority of German application No. 10 205 057 779.2 filed Dec. 2, 2005, which is incorporated by reference herein in its entirety.

### FIELD OF INVENTION

The invention relates to an arrangement for data transmission between an image source and an image reproducing system, with digital R/G/B video signals being able to be fed to the image reproducing system by the image source by way of an R/G/B path pair in each instance and a communication signal. Furthermore, the invention relates to an image reproducing system and an image source for an arrangement of this type.

### BACKGROUND OF INVENTION

The requirements made on display quality are rising increasingly in respect of digital image reproducing systems, e.g. an image reproducing system in the form of an LCD display module or an LCD television. To satisfy these requirements, different corrections and/or adjustments are necessary, for instance an adjustment in the form of a compensation of pixel noise, an acceleration of switching times, an adjustment of the luminance distribution and/or an adjustment of the image reproduction characteristic curve. By way or example, the adjustment of the image reproduction characteristic curve requires a high data volume to be transmitted to the image reproducing system. The image reproduction characteristic curve specifies how an electrical image signal is converted into an optical signal composed of luminance density and chrominance. The image reproduction characteristic curve can be adjusted with the aid of a so-called Look-Up Table, e.g. in the manner such that the image reproduction characteristic curve corresponds to the DICOM standard, with a plurality of test images being necessary for this comparison, said test images each representing a test pattern. By way of example, approximately 33 gray scales are compared for the foreground and approximately 50 gray scales are compared for the background. This means that a high data volume must be transmitted to the image reproducing system for a compensation of this type.

Data is usually digitally exchanged for instance between an image source, e.g. an image source in the form of a graphics card of a personal computer, and an LCD display module. The personal computer transmits digital RIG/B video signals to the LCD display module via a special, so-called DVI (Digital Video Interface) cable, which features a path pair for each R, G and B channel. This DVI cable is also provided with further path pairs, in particular for transmitting a DVI clock signal and for transmitting so-called DDC (Display Data Channel) data. This DDC path pair enables a serial communication between the personal computer and the LCD display module, with specification information of the LCD display module, e.g. information about data transmission rates, resolution of the LCD display or synchronization frequency being transmitted in particular via a data line and a DDC clock signal being transmitted via a clock line.

To this end, the DDC path pair is frequently used to transmit data for adjusting the image reproduction characteristic curve to the LCD display module, with, in accordance with the 12C BUS specification, the data transmission rate over this DDC path pair only amounting to 100 kBit/sec, which means that said data transmission takes up a large amount of time.

The data transmission rate can be increased and the transmission duration thus reduced by using a so-called USB (Universal Serial Bus) cable. However, this means that an additional cable is required to connect the personal computer to the LCD display module, with suitable interfaces having to be provided to connect said cable.

### SUMMARY OF INVENTION

A object underlying the present invention is thus to simplify a data transmission in an arrangement of the type cited at the beginning and to shorten the transmission time needed to transmit large data volumes. Furthermore, an image reproducing system and an image source which are suited to an arrangement of this type are to be specified.

This object is achieved by the independent claims and also in respect of a image reproducing system and of an image source.

It is advantageous that a DVI cable known per se and widely used, which is essentially provided for the transmission of digital R/G/B video signals, can be used to transmit large data volumes, e.g. large data volumes in the form of data to adjust the luminance distribution and/or to adjust the image reproduction characteristic curve, at high data transmission rates from the image source to the image reproducing system. An additional cable is not necessary.

### BRIEF DESCRIPTION OF THE DRAWING

The invention is described in more detail below on the basis of an exemplary embodiment with reference to the sole figure of the drawings. The figure in the drawings shows a simplified arrangement for data transmission.

### DETAILED DESCRIPTION OF INVENTION

An image source in the form of a personal computer 1 with a suitable graphics card is connected to an image reproducing system in the form of an LCD display module 3 by means of a DVI cable 2 known per se. The DVI cable 2 exhibits suitable connecting means 4a, 4b, by means of which the connecting means 4a interact electrically and mechanically with a connecting means 5 of the personal computer 1 and the connecting means 4b interact electrically and mechanically with the connecting means 6 of the LCD display module 3. These connecting means 4a, 4b, 5, 6, which could be designed as plug-in contacts known per se and/or sockets corresponding thereto and the DVI cable 2 allow information to be exchanged between the personal computer 1 and the LCD display module 3, this being indicated in the drawing using dashed and dotted lines.

The DVI cable 2 has three path pairs (channels) 7, 8, 9 for transmitting digital R/G/B video signals and also a further path pair 10 for transmitting a DVI clock signal DVI clock with a first clock frequency of 165 MHz for instance. Furthermore, the DVI cable 2 is provided with a DDC (Display Data Channel) and a DDC clock line 11, 12, with standard specification information SDA of the LCD display module, e.g. information about the resolution of the LCD display or of the synchronization frequency, being transmitted via the display data line 11 in video operating mode, and a DDC clock signal SCL being transmitted with a second clock frequency of 100 kHz via the clock line 12.

The display data line 11, which, as described, is usually provided in a video operating mode as a communication line for transmitting specification data, as well as the path pairs 7, 8, 9 usually provided in this video operating mode for transmitting the R/G/B video signals, are used to transmit huge data volumes, as indicated below. To this end, a communication operating mode can be set, in which provision is made to transmit large data volumes via at least one path pair 7 of the R/G/B path pairs 7, 8, 9.

For simplicity, it is assumed in the exemplary embodiment that data is only transmitted via the path pair 7. In a practical exemplary embodiment of the invention, data is transmitted via all R/G/B video channels, thereby achieving a higher data transmission rate. A data transmission program 13 which can be run on the personal computer 1, said data transmission program naturally being able to be a component of a graphics processing program, indicates to a microcontroller 14 via the display data line 11 that no digital R/G/B video signals are transmitted in a video operating mode in a subsequent data transmission cycle, but instead data is transmitted via the path pair 7 in a communication operating mode. The microcontroller 14 acknowledges the display to the data transmission program and controls an electronic switch 15 such that the data fed from the personal computer 1 to the LCD display module 3 via the path pair 7 during the transmission cycle is not transmitted to a video electronics system (not shown), but is instead written into a data storage device 16. The data transmission is terminated, with the microcontroller 14 indicating to the data transmission program 13 of the personal computer 1 that the data is stored in a storage device 16 and the communication operating mode has ended. In a further transmission cycle, the personal computer 1 can transmit further data in a further communication operating mode or video signals in a video operating mode to the LCD display module 3. The data stored in the data storage device 16 can be called up and further processed in an adjustment or correction phase by means of a graphics controller of the LCD display module 3 for instance.

1.-3. (canceled)

4. An image transmitting system, comprising:
an image source;
an image reproducing system;
a R/G/B cable connected between the image source and the image reproducing system that transmits digital R/G/B video signals from the image source to the image reproducing system;
a communication signal send from the image source to the image reproducing system that indicates a communication operating mode to the image reproducing system, the communication operating mode providing information about transmitting data via the R/G/B cable;
a data storage device operatively connected to the R/G/B cable that stores data transmitted via the R/G/B cable; and
a data dispatcher that operatively connects the R/G/B cable to the data storage device as directed by the communication operating mode.

5. The image transmitting system as claimed in claim 4, wherein the R/G/B cable comprises pairs of wire, wherein each of the three digital R/G/B video signals is designated to one pair of wire.

6. The image transmitting system as claimed in claim 5, wherein the dispatcher connects a pair of wires to the data storage device.

7. The image transmitting system as claimed in claim 4, wherein the R/G/B cable is a DVI-cable.

8. The image transmitting system as claimed in claim 4, wherein the data stored in the storage device relates to data for adjusting a luminance distribution.

9. The image transmitting system as claimed in claim 4, wherein the data stored in the storage device relates to data that adjusts an image reproduction characteristic curve.

10. The image transmitting system as claimed in claim 4, wherein a personal computer is operatively connected to the image source and the image reproducing system.

11. The image transmitting system as claimed in claim 4, wherein the image reproducing system is a LCD display.

12. The image transmitting system as claimed in claim 4, wherein the RIG/B cable is connected physically between the image source and the image reproducing system.

13. A method for transmitting data between an image source and an image reproducing system, comprising:
sending a communication signal from the image source to the image reproducing system to indicate a communication operating mode;
sending digital R/G/B video signals from the image source to the image reproducing system via a R/G/B cable; and
sending data from the image source to a storage device via the R/G/B cable if indicated by the communication operating mode.

14. The method as claimed in claim 13, wherein using a R/G/B cable comprising pairs of wire, wherein each of the three digital R/G/B video signals is designated to one pair of wires.

15. The method as claimed in claim 14, wherein a dispatcher is dispatching transmitted data to the storage device via a pair of wires.

16. The method as claimed in claim 15, wherein the dispatching of the pair of wire is performed as directed by the communication operating mode.

17. The method as claimed in claim 13, wherein a microcontroller acknowledges the indication and controlls an electronic switch such that during a transmission cycle the data is transmitted to the storage device.

18. A method for transmitting digital information between an image source and an image reproducing system, comprising:
sending digital information via a RIG/B cable connecting the image source and an image reproducing system; and
dispatching the digital information transmitted via the RIG/B cable between the image reproducing system and a storage device.

19. The method as claimed in claim 18, wherein a data transmission program indicates a microcontroller that in a subsequent data transmission cycle digital information is dispatched.
